(19) United States
(12) Patent Application Publication
(10) Pub. No.: US 2004/0252247 A1
(43) Pub. Date: Dec. 16, 2004

(54) System for management of decoding devices and method for management of decoding devices

(76) Inventor: Zbigniew Wabiszczewicz, Zielona Gora (PL)

Correspondence Address: SCHOLL PATENT AGENCY, INC., DR. MATTHIAS SCHOLL, 800 MAIN ST, #308, HOLDEN, MA, 01520, US

(21) Appl. No.: 10/851,613

(22) Filed: May 22, 2004

(30) Foreign Application Priority Data
May 26, 2003 (PL) P-360344

(51) Int. Cl. H04L 25/34; G06F 13/00

(52) U.S. Cl. 348/734; 725/58

(57) ABSTRACT

A system for management of decoding devices consists of at least one slave decoding device (112, 113) and a master decoding device (111). A master remote control unit (a master RCU) (121) controls slave decoding devices (112, 113) and the master decoding device (111) and is assigned individually to the master decoding device (111). At least one slave remote control unit (a slave RCU) (122, 123) controls individually assigned one slave device (112, 113). Each slave decoding device (112, 113) of the system includes a controller (207) controlling operation of a signal processing block (203). The controller (207) includes a timer (208) and a command analyzer (209). The timer (208) is used for defining the time of transition from a normal mode to a waiting mode of the slave decoding device (112, 113) and from the waiting mode to an inactive mode. The command analyzer (209) is used for recognizing commands of the master RCU (121), which cause a transition of the slave decoding device (112, 113) to the normal mode.

### CROSS-REFERENCE TO RELATED APPLICATIONS

This application claims priority to Polish Application No. P-360344, filed May 26, 2003, the contents of which are incorporated herein by reference.

### BACKGROUND OF THE INVENTION

1. Field of the Invention

The present invention relates to a system for management of decoding devices, which contains a master decoding device and slave decoding devices forming with the master decoding device a set of decoding devices controlled by remote control units, and a method for managing decoding devices formed in the set.

2. Brief Description of the Background of the Invention Including Prior Art

The development of digital television and a considerable reduction of production costs of devices related to it caused a growth of demand for digital television decoders. For example, when there are a few television receivers at home and members of the household would like to watch various programs on each TV, a separate decoder can be purchased and connected to each TV receiver. However, one should notice that the decoders are quite expensive devices. In a commonly applied sale system, if a user wants to purchase a second decoder for himself, the television operator (decoder supplier) offers such decoder at a lower price. The operator, offering a decoder at a lower price, would like to make sure that it will be used according to the agreement, and thus by the user, who purchased it.

There is a method of managing access to network and a device, controlling access to network through the master and the slave decoder, known from U.S. Pat. No. 5,748,732 entitled “Pay TV method and device, which comprise master and slave decoders”. The master decoder receives information from central management unit for controlling operation of the slave decoder, which is written to the electronic card of the slave decoder.

There is a system of digital television decoders, known from U.S. Pat. No. 6,405,369, entitled “Smart card chaining in pay television systems”, which includes the first and the second decoder, which have the first and the second electronic card assigned to them. These cards deactivate after a certain time, and their repeated activation is possible by using the first card in the second decoder and the second card in the first decoder. A drawback of this system is that information about the activation time is stored in the card, which requires this card to be equipped with erasable memory. Moreover, if in a decoder, which performs activation, there is only one card reader, the removal of the card from the reader can cause an interruption in operation of the decoder. Therefore, this method requires application of advanced cards and it is troublesome for the user.

There is a television receiver, which can receive various command codes from different remote control units, known from the U.S. Pat. No. 6,359,661. The receiver, based on received command codes, recognizes the user and adjusts its operation to the user profile.

### SUMMARY OF THE INVENTION

### PURPOSES OF THE INVENTION

It is an object of this invention to provide a simple method of protecting a set of a master and slave decoders, associated with it, from moving them to other buildings.

It is another object of this invention to provide a method for increasing security of operator's investment, by allowing decoders to be used only by authorized users and not resold to unauthorized users.

These and other objects and advantages of the present invention will become apparent from the detailed description, which follows.

### BRIEF DESCRIPTIONS OF THE INVENTION

In a system of managing decoding devices, containing a master decoding device and at least one slave decoding device, controlled by remote control units (RCU), the master decoding device is controlled by a master RCU, assigned individually to the master decoding device. The slave decoding device is controlled by a slave RCU, assigned individually to one slave device and the master RCU that is assigned individually to the master decoding device. The slave decoding device contains a controller, for controlling the operation of the signal processing block, which includes a timer and an RCU commands analyzer. The timer is used for defining the transit time from a normal mode to a waiting mode of the slave decoding device and from the waiting mode to an inactive mode, and the RCU commands analyzer is used for recognizing commands of the master RCU, which cause a shift of the slave decoding device to the normal mode. The sequence of commands of the master RCU can be changed at each transit to the normal mode of the slave decoding device. The timer can measure a defined constant time period or a time of operation of the slave decoding device or period of time from a defined range of values. The controller that controls the operation of the signal processing block in the waiting mode, generates on the screen of the TV receiver a time, which remains until transit to the inactive mode. The controller that controls the operation of the signal processing block in the inactive mode, blocks the display of sound and/or picture received by television signal.

The essence of the invention is also that in the method of managing decoding devices, controlled by remote control units, there is a set, which consists of the master decoding device, controlled by the master RCU, assigned to it individually and at least one slave decoding device, controlled by the slave RCU, assigned individually to one slave device and controlled by the master RCU, assigned individually to the master decoder. Whereas, the slave decoder includes a controller, managing the operation of the signal processing block, which includes the timer and the analyzer of RCU commands. The timer is used to define the transit time from the normal mode to the waiting mode of the slave decoding device and from the waiting mode to the inactive mode, and the RCU command analyzer is used to recognize commands of the master RCU, which cause a transit of the slave decoding device to the normal mode.

The novel features, which are considered as characteristic for the invention, are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown, where

FIG. 1 is a system for management of decoding devices shown schematically;

FIG. 2 shows a block diagram of a remote control unit and a decoder;

FIG. 3 shows a diagram of operation of a controller of a signal receiving block;

FIG. 4 shows exemplary methods of operation of a timer in different modes;

FIG. 5 shows an exemplary timer;

FIG. 6 shows a flow chart of operation of the controller in a normal mode;

FIG. 7 shows a flow chart of operation of the controller in a mode of waiting for activation;

FIG. 8 shows a flow chart of operation of the controller in an inactive mode;

FIG. 9 shows a flow chart of procedure of setting the timer in a normal mode;

FIG. 10 shows a flow chart of procedure of setting the timer in the mode of waiting for activation; and

FIGS. 11, 12, 13, 14 and 15 show exemplary views of receiver screens.

### DESCRIPTION OF INVENTION AND PREFERRED EMBODIMENT

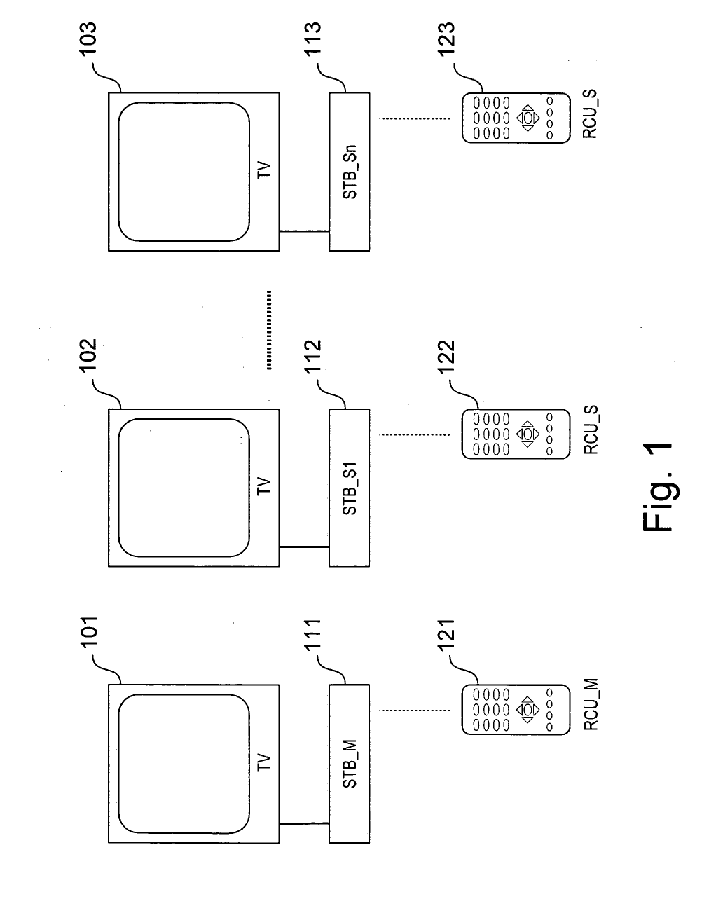

A system, according to the invention, consists of a master decoding device, defined hereunder briefly in the description as a master decoder, and at least one slave decoding device, defined in the description as a slave decoder, is shown in FIG. 1. The master decoder 111 receives a television signal and transmits it to a television receiver 101. The master decoder 111 is monitored by a master RCU 121, which is individually assigned to the master decoder 111, which means that the master decoder 111 reacts to signals sent only by the master RCU 121. A first slave decoder 112 receives a television signal and transmits it to a television receiver 102. The first slave decoder 112 is controlled by the first slave RCU 122, which is individually assigned to the first slave decoder 112, which means that the first slave decoder 112 reacts only to signals, broadcasted only by the first slave RCU 122 or the master RCU 121, assigned to the master decoder 112, associated with the first slave decoder 112. It is also possible that slave decoders react to signals of each slave RCU and the master RCU, assigned to control the master decoder, which belongs to the set, to which slave decoders belong. The set can include also further slave decoders. The N-th slave decoder 113 receives television signal and transmits it to the television receiver 103. The slave decoder 113 is controlled by the slave RCU 123, which can be identical for all slave decoders. The decoders can, but do not have to be connected to common sources of television signal. The RCU sends to the decoder codes of commands, which correspond to keys pressed by the user. The essence of the system is that the codes of commands for the master RCU 121 and the slave RCU 122, 123 are different.

The essence of the invention is that slave decoders 112, 113 are programmed in such a way that during the mode of waiting for authorization, they require a use of the master RCU 121, used for servicing the master decoder 111, which belongs to the same set as slave decoders 112, 113. In order to prevent an exchange of remote control units between decoders, the master decoder 111 must react only to commands of the master RCU 121, similarly to slave decoders 112, 113, which must react additionally to commands of slave RCUs.

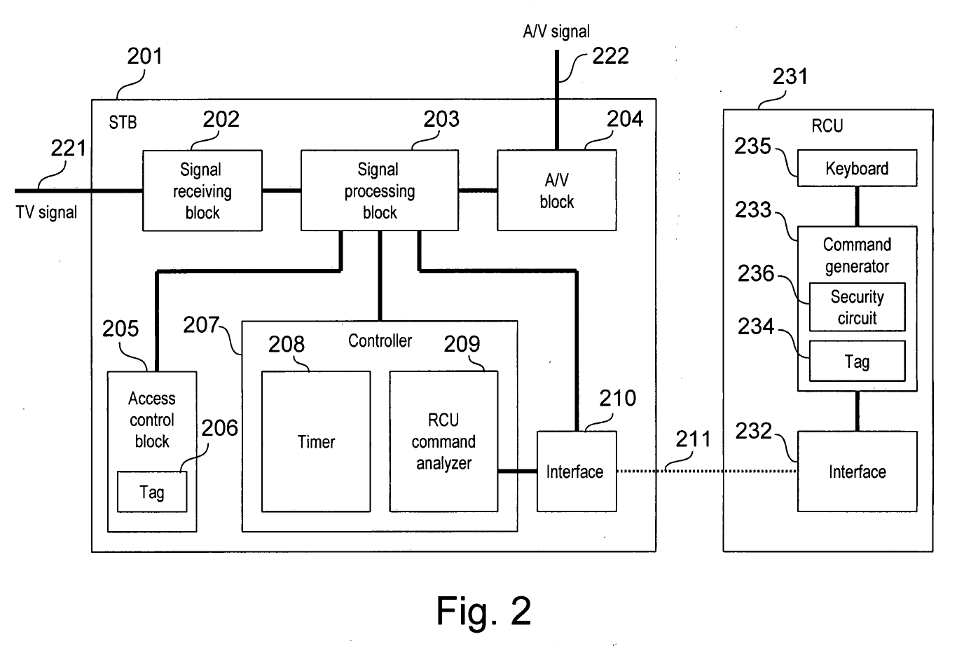

The block diagram in FIG. 2 shows the internal structure of the RCU and the decoder. The signal receiving block 202 of the decoder 201 receives the television signal 221 and transmits it to the signal processing block 203. After processing, the signal is converted in an A/V block 204 into an A/V signal 222 in a form acceptable by the television receiver. The decoder 201 includes access control block 205, which on the basis of information read from electronic cards controls a signal display. The decoder 201 includes also an interface 210, for example an infrared radiation receiver, which transmits data received from a signal 211 of RCU 231, to an analyzer 209 of RCU commands. The RCU 231 contains a keyboard 235, by means of which the user selects commands, controlling operation of the decoder 201, and also a command generator 233, which assigns appropriate code to the command selected by the user, and an interface 232, for example a transmitter of infrared signal, which receives data from command generator 233 and sends them in a signal 211 to the decoder 201. A new element of the decoder in the system according to the invention is a controller 207 of signal processing block, which contains a timer 208 measuring the time of operation in specific modes and an analyzer 209 of RCU commands. The analyzer 209 of RCU commands is used for specifying the type of remote control unit, which sends the command to the decoder. Recognition of a specific command, broadcasted by the master RCU in the analyzer 209 of the slave decoder allows the slave decoder to switch to the working mode from the waiting mode and from the inactive mode. The controller 207 analyzes signals of timer 207 and the analyzer 209 and controls operation of signal processing block 203 adequately. The new elements of the system, according to the invention, are also a decoder tag 206, which belongs to a block 205 of access control and a remote control unit tag 234, which define, if a given device is a master device, or a slave device. This allows making slave and master devices in an almost identical way, where the tags are the only difference between them. It is also possible to make devices and remote control units in separate master and slave versions. At that time the difference between remote control units will be in codes of commands sent by them. The slave decoder in comparison to the master decoder will have additionally the above-described controller of signal processing block. Moreover, the master RCU's command generator, in comparison to the slave RCU's command generator contains a safety system 236, which is used to generate commands of the RCU in a safe way, i.e. in a way which prevents dishonest users from programming the universal RCU for commands sent by the master control unit. A universal RCU is a remote control unit, which has a reader of signals of another RCU and a multiplier of signal, which allows it to imitate the operation of another remote control unit. The safety system can change the codes sent by it or scramble them in a specific way. Due to this, it will not be possible to copy it by a universal remote control unit. When the master RCU contains a safety device, then the RCU commands analyzer or another block in the decoder has appropriate functionality, which allows reading protected commands. Application of the RCU tag 234 facilitates making master and slave RCUs with similar software. The tag is used by a command generator 233 in order to define the code of command, which is to be sent to the decoder. Commands generated by the command generator 233 can be selected in two similar ways. In the first way, the command generator 233 contains two sets of commands. One of them is a set of master command codes, and the second is a set of slave command codes. Before selecting a code of command, the generator checks the value of the tag, and on the basis of it, selects a command from appropriate set. In the second method, the generator contains one set of command codes. A tag is added to specific code, which is fetched. For example, command codes can be written by means of seven bits. One bit, which defines a type of command—the master or the slave command—will be appended to them at the end or at the beginning. The RCU tag can also be defined in another way, selected by the designer of the system. For example, the tag can be located in a specific place in the memory. The RCU tag can also be set by the user. For example, the master RCU tag can be activated by inscribing a specific access code for the remote control unit. Another solution is to resign from the application of the RCU tag and execute two different versions of RCU software. However, such solution brings about higher production costs. The decoder tag 206 is used for activation of the controller 207 of the signal reception block. When the decoder tag marks the master decoder, the decoder is inactive. Detection of the tag of the slave decoder activates the controller. The decoder tag can be stored in a specific place of the memory. The decoder tag can also be activated by entering a specific access code. The decoder tag can also be read from an electronic card. At that time the master and slave decoders can be identical and the electronic card decides about their function.

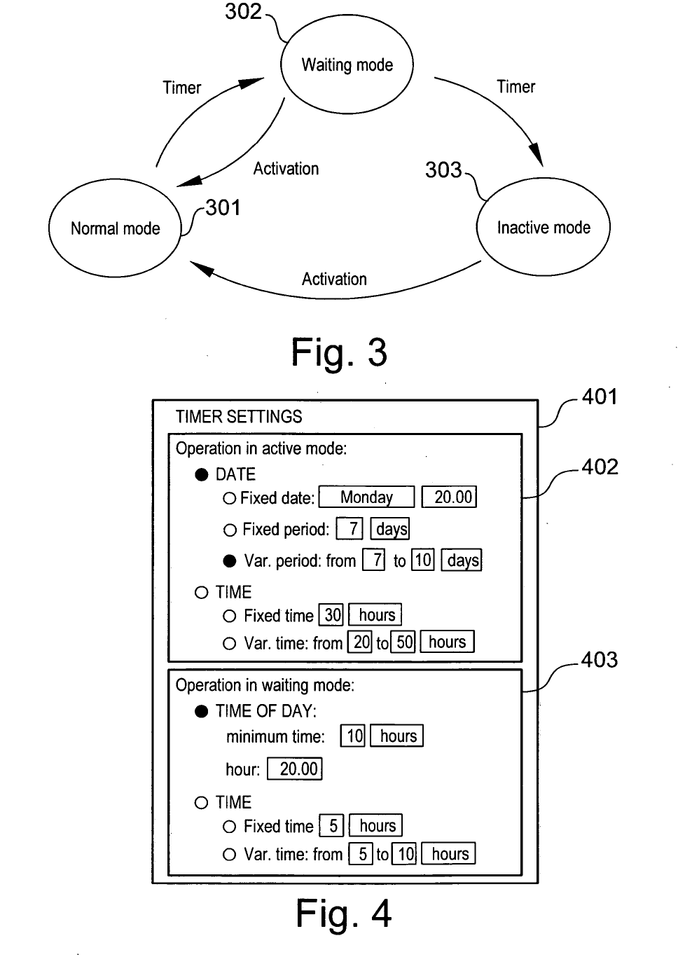

FIG. 3 illustrates a diagram of operation of the controller of signal receiving block. The controller monitors the modes of operation of signal receiving block, and thereby, modes of operation of the slave decoder. Transitions between the modes are possible after specific conditions are met. A transition from the operation mode of the slave decoder, defined also as normal mode 301, to waiting mode 302, takes place after elapse of time, measured by the timer in a decoder in normal mode. A return to normal mode 301 takes place if during the time, measured by the timer, in a decoder in waiting mode 302, activation by the master RCU occurs. If there is no activation in this time, the slave decoder moves to inactive mode 303. A return from inactive mode 303 to normal mode 301 is possible by means of activation by the master RCU. The timer can be set in different ways.

FIG. 4 illustrates a structure 401 describing exemplary methods of operation of the timer in different modes, which, in greater detail, are illustrated in form of fields 402 and 403. These options can be available for the user or only for the designer of the system. It is obvious that in the system, the designer can apply a timer with such or similar operational options, or a timer with one, predefined method of operation. And thus the field 402 defines a method of operation of the timer in active mode. It can operate in a configuration of DATE and TIME or their combination. In the DATE configuration, a transition to waiting mode takes place on a specific day and at a specific hour:

on a specific day of week (for example on every Monday at 20.00)

in a specific time since the time of last activation (for example in seven days)

at random periods since the time of last activation, selected from a specific timer range (for example ranging from seven to ten days)

In the TIME configuration, a transition to waiting mode occurs, after a specific time of inactivity of the receiver from the time of last activation,

after a specific time (e.g., after 30 hours of watching);

after a time selected at random from a specific time range (e.g. after a time in between 20 and 50 hours).

The field 403 defines a method of operation of the timer in the mode of waiting for activation. It can operate in configuration of TIME OF THE DAY and TIME or their combination. In configuration TIME OF THE DAY, activation must take place at the latest at a specific time of the day, until a specific hour. In this configuration a minimum time and hour are defined, before which activation must take place. If the time between transition to waiting mode and the required activation hour will be shorter than the minimum time, activation will be required on the next day. If it is longer, activation will be required on the same day. In the given example, the minimum time is 10 hours, and request of activation is set at 20.00. Thus, if transition to waiting mode takes place at 12.00, the user will have time for activation until 20.00 of the next day.

In the TIME configuration, activation must take place in a specific time from the moment of transition to waiting mode:

after a specific time (e.g. after 5 hours);

after a random time from a selected range (e.g. after 5 to 10 hours).

In the exemplary structure of data 401 from FIG. 4, in active mode, configuration DATE was selected with setting of variable time from 7 to 10 days, while in the waiting mode configuration of TIME OF THE DAY was selected with setting of minimum time at 10 hours and activation hour set at 20.00.

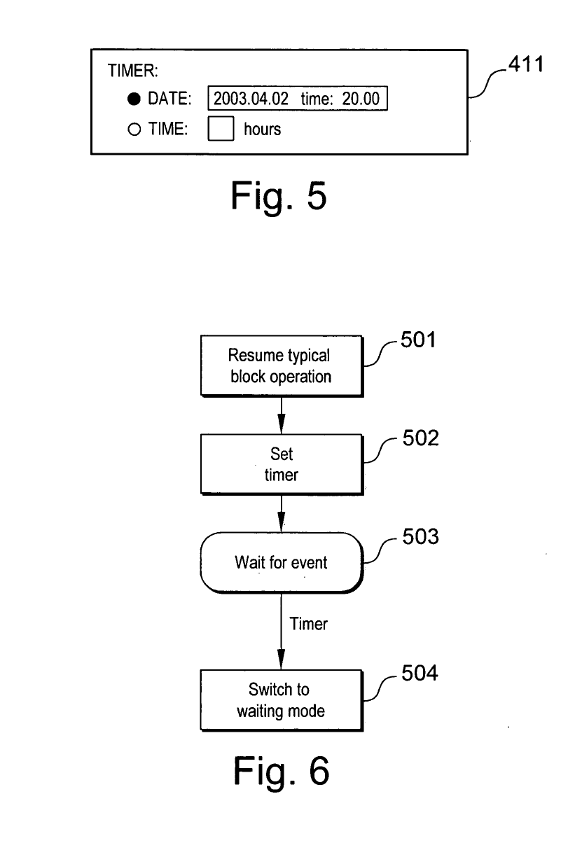

FIG. 5 shows an exemplary timer. The time of activation is set in the timer. It can be a specific day with a particular hour (in the example: 2003.04.02, 20.00) or a specific time. The time can specify the number of hours of active operation of the receiver. Then, during operation of the receiver time is appropriately shortened until it reaches null.

A method of operation of the controller in the normal mode is illustrated in FIG. 6. In step 501, the controller restores a typical way of operation of the signal receiving block. Next, in step 502, it sets the operation time of the timer, and in step 503 it waits for an event. When the event is caused by the timer, which means, that the time measured by it has elapsed, in step 504 the controller switches to the mode of waiting for activation.

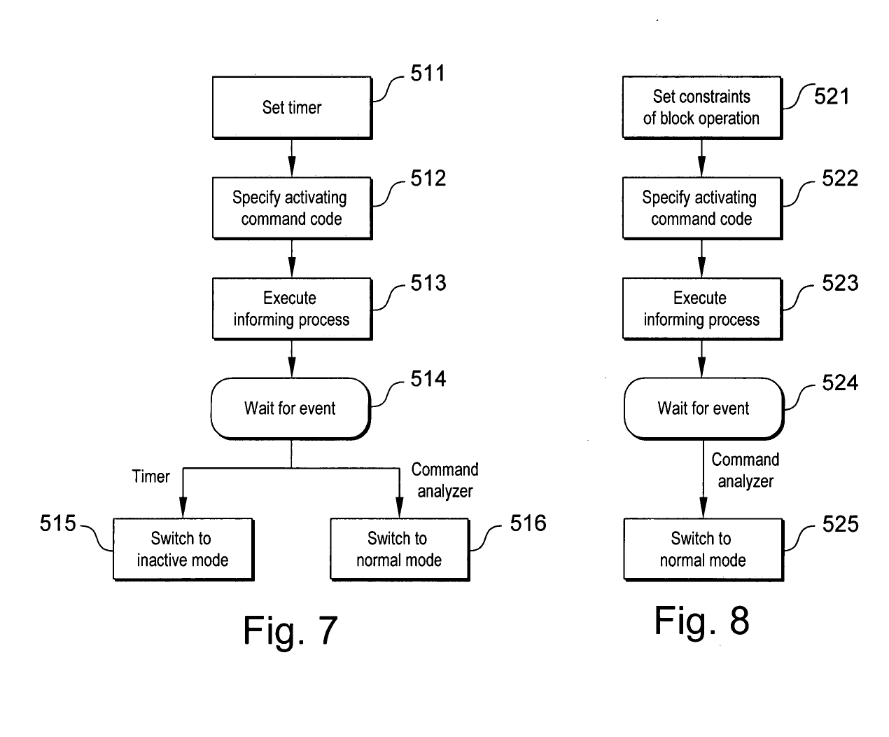

A method of operation of the controller in the mode of waiting for activation is illustrated in FIG. 7. In step 511 the operation time of the timer is set. Next, in step 512, in the commands analyzer, the code of activating commands is defined, which is described later in the description. A process, which is started in step 513, informs about the status of operation of the decoder in the mode of waiting for activation. This process continuously or periodically generates information about the duty of the user to perform activation. Additionally, the user can be informed about the time, which remains until transition into inactive mode. Additionally, the user can be informed about the command, or a set of commands of the RCU, which must be used in order to perform activation. In step 514, the controller waits for an event. If an event is caused by the timer, which is equal to the elapse of the time, measured by it, the controller switches into inactive state in step 515. If the event is caused by the commands analyzer, which means that the commands analyzer detected a command or a set of activating commands, the controller switches into normal mode in step 516.

FIG. 8 illustrates a method of operation of the controller in the inactive mode. In step 521, the controller sets limits in the operation of signal receiving block. For example, the controller can block generation of sound or picture, or both sound and picture. Such limitations can be set for all or only for specific channels (for example, channels with a higher fee). Next, in step 522, in a command analyzer, the controller defines the code of activating command. It can be the identical activating command as the one in the mode of waiting for activation. In step 523, the controller starts a process of informing about operation in the inactive mode. This process continuously or periodically generates information about the duty of the user to activate. Additionally, the user can be informed, which command or a set of RCU commands must be used in order to perform activation. In step 524 the controller waits for an event. If the event is caused by commands analyzer, which means that the commands analyzer detected a command or a set of activating commands, the controller switches to normal mode in step 525.

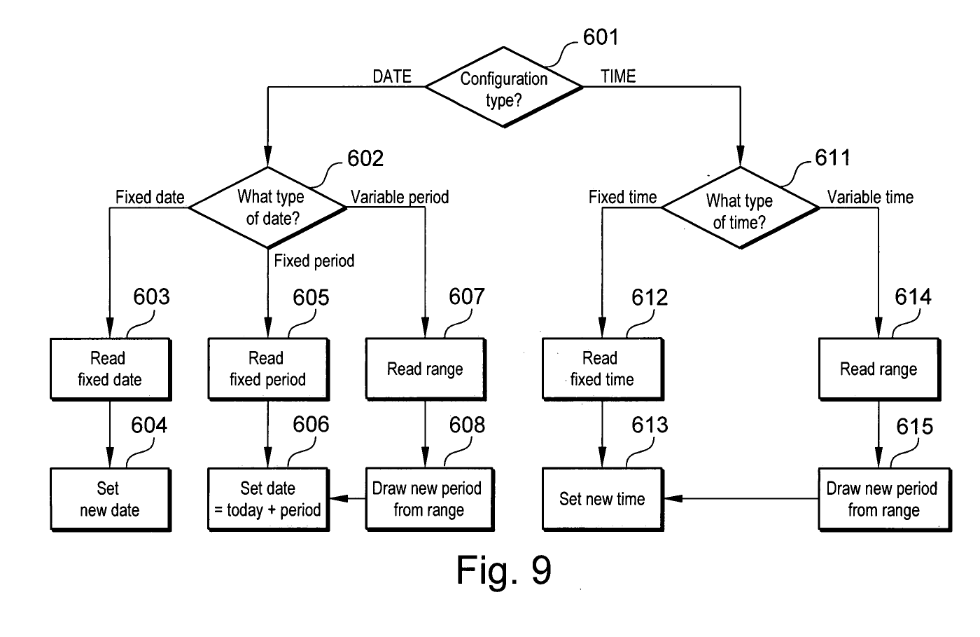

The procedure of setting the timer in normal mode is illustrated in FIG. 9. In step 601 the configuration of the timer is checked. If the timer is set in the DATE configuration, the date settings are checked in step 602. If there is a constant date defined, this date is read in step 603. Next, in step 604, this date is set in the timer. If there is a constant period defined, this period is read in step 605 and the date, which is calculated by summing up the date of the current day and the set period, is set in the timer, in step 606. If there is a variable period defined, then in step 607 the range is read. In step 608 a period from the range is drawn and the appropriate date is set in the timer in step 606. If timer is set in the TIME configuration, the time settings are checked in step 611. If there is a constant time defined, it is read in step 612 and set in the timer in step 613. If there is a variable time defined, the range is read in step 614, and the time from the range is drawn in step 615 and this time is set in the timer in step 613.

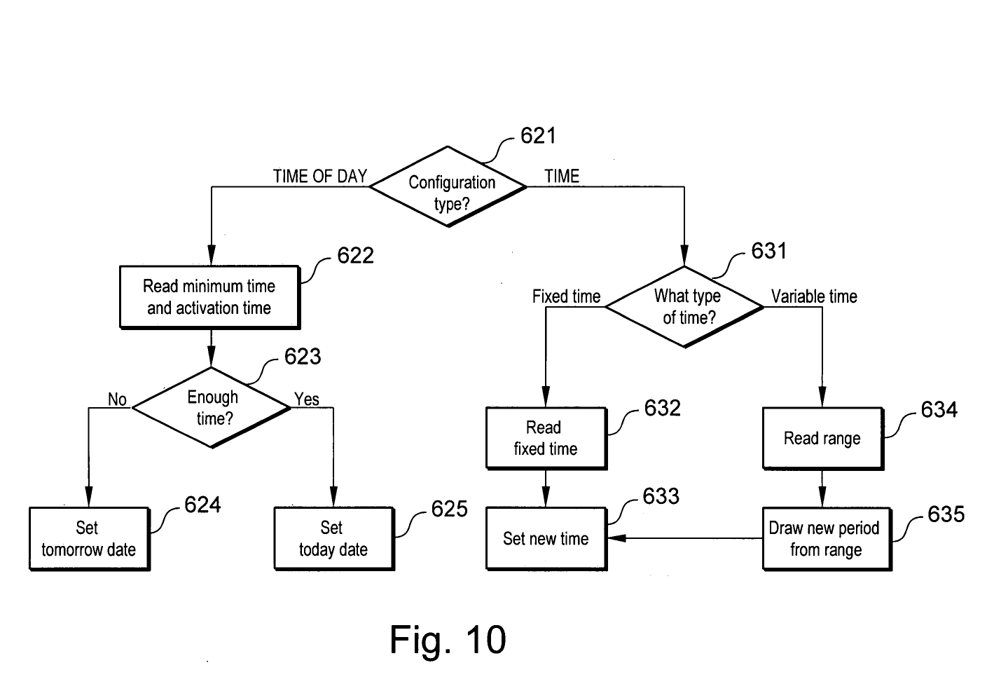

The procedure of setting the timer in the mode of waiting for activation is illustrated in FIG. 10. In step 621 configuration of the timer is checked. If the timer is set in the configuration of TIME OF THE DAY, the minimum and activation times are read in step 622. Next, in step 623, the period between the requested activation time and the current time is compared in step 623. If the time for activation is sufficient, the timer is set on the date of the given day and requested hour of activation in step 625. If there is not enough time for activation, the timer is set on the date of the next day and requested hour of activation in step 624. If the timer is set in configuration of TIME, the time settings are checked in step 631. If there is a constant time defined, this time is read in step 632 and set in the timer in step 633. If there is a variable time defined, the range is read in step 634, the time is drawn from range 635 and it is set in the timer in step 633. In the mode of waiting for activation and in inactive mode, codes of activating command or commands are defined. These codes must be received from the master RCU. Commands analyzer monitors the command, received by the decoder and in case this specific command or commands are received, a specific signal is sent to the controller. In the simplest example of embodiment, any command, sent from the master RCU can be an activating command, which is the most convenient solution for the user. In another case, this can be a specific command, for example a change of sound volume, channel or power button. In a more advanced solution, the activating command can be changed at each definition of the activating command or a set of commands can be defined (for example, specific numeral access code). At that time the activating command or commands will be given by informing process.

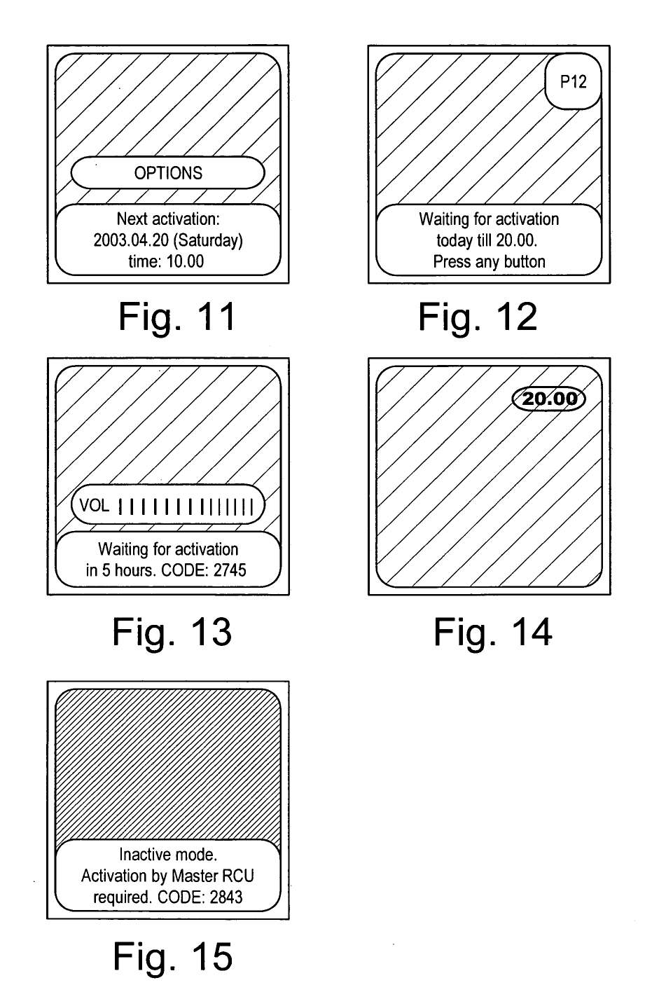

FIGS. 11, 12, 13, 14 and 15 illustrate exemplary views of the screen of the receiver, with information about the current operating mode and the method of activation.

FIG. 11 shows a television screen, which is in active mode, with information about the date of transition into waiting mode. Such information can be fetched from menu of decoder's options.

FIG. 12 shows the receiver's screen in the mode of waiting for activation, with information about an hour, until which activation should be performed (with any button of the master RCU). Such screen can be displayed upon a change of a channel, along with information about the number of the newly selected channel.

FIG. 13 shows a screen in the mode of waiting for activation with information about the allowed time, which remains for performing activation (by means of a specific sequence of buttons of the master RCU). Such screen can be activated, when decoder's settings, e.g. sound volume is changed.

FIG. 14 illustrates an exemplary method of submitting information about the requested hour of activation. In this method the hour appears periodically on the screen of the television receiver, for example, every half an hour for 3 seconds. Such method does not interfere much with user's reception of watched program.

FIG. 15 shows a screen in inactive mode with information on how to activate the decoder by means of a specific sequence of buttons (for example, 2843).

The above information, displayed on the screens of the receiver, should be treated only as exemplary. It will be obvious for a specialist to design another view of the screen, which will present more or less detailed information, more or less drawing attention of the user. The presented solution shows a method of protecting the set of the master decoder and slave decoders, associated with it. This method is simple in realization. For the reason that the slave decoder requires periodical activation by the master RCU, it would be very difficult to move decoders at a considerable distance from one another, for example to move them to separate apartments or buildings. Therefore, the method makes the investments of the operator more secure, because decoders will be used only by authorized users and will not be resold to unauthorized users. The system is useful, especially in case, when the user receives slave decoders at a low price.

The preferred embodiments having been thus described, it will now be evident to those skilled in the art that further variation thereto may be contemplated. Such variations are not regarded as a departure from the invention, the true scope of the invention being set forth in the claims appended hereto.

What is claimed is:

1. A system for management of decoding devices comprising
at least one slave decoding device;
a master decoding device;
a master remote control unit (a master RCU) for controlling slave decoding devices and the master decoding device and assigned individually to the master decoding device;
at least one slave remote control unit (a slave RCU) for controlling individually assigned one slave device wherein said slave decoding device includes a controller, controlling the operation of the signal processing block, and which includes a timer and a command analyzer and wherein the timer is used for defining the time of transition from a normal mode to a waiting mode of said slave decoding device and from the waiting mode to an inactive mode, and wherein the command analyzer is used for recognizing commands of the master RCU, which cause a transition of said slave decoding device to the normal mode.

2. The system for management, according to claim 1, wherein a signal of transition of said slave decoding device to the normal mode is generated on the basis of a random command of the master RCU.

3. The system for management, according to claim 1, wherein a signal of transition to the normal mode of said slave decoding device is generated on the basis of a defined command of the master RCU.

4. The system for management, according to claim 1, wherein a signal of transition to the normal mode of said slave decoding device is generated on the basis of a defined sequence of commands of the master RCU.

5. The system for management, according to claim 4, wherein the defined sequence of commands of the master RCU is predefined.

6. The system for management, according to claim 4, wherein the sequence of commands of the master RCU is changed at every transition to the normal mode of said slave decoding device.

7. The system for management, according to claim 1, wherein the timer measures a defined constant period of time.

8. The system for management, according to claim 1, wherein the timer measures the time of operation of said slave decoding device.

9. The system for management, according to claim 1, wherein the timer defines constant times of activation.

10. The system for management, according to claim 1, wherein the timer measures the time periods, from a defined range of values.

11. The system for management, according to claim 1, wherein the controller controlling the operation of the signal processing block in the waiting mode generates on a screen of TV receiver the time, which remains until transition into the inactive mode.

12. The system for management, according to claim 1, wherein the controller monitoring the operation of the signal processing block in the inactive mode, blocks display of sound and/or picture of a received television signal.

13. A method for management of decoding devices controlled by remote control units comprising following steps
forming a set of a master decoding device controlled by a master RCU, which is individually assigned to the master decoding device, and of at least one slave decoding device controlled by a slave RCU assigned individually to said slave device and controlled by the master RCU wherein said slave decoding device, which includes a controller monitoring operation of signal processing block, and which includes a timer and an analyzer of commands of the slave RCU and the master RCU is used for recognizing commands of the master RCU, which cause a transition of said slave decoding device to a normal mode.

14. The method for management, according to claim 13, wherein a signal of transition of said slave decoding device to the normal mode is generated on the basis of a random command of the master RCU.

15. The method for management, according to claim 13, wherein a signal of transition of said slave decoding device to the normal mode is generated on the basis of a specific command of the master RCU.

16. The method for management, according to claim 13, wherein a signal of transition of said slave decoding device to the normal mode is generated on the basis of a specific sequence of commands of the master RCU.

17. The method for management, according to claim 16, wherein the sequence of commands of the master RCU is predefined.

18. The method for management, according to claim 16, wherein the sequence of commands of the master RCU is changed at each transition of the slave decoding device to the normal mode.

19. The method for management, according to claim 13, wherein the timer measures a defined constant period of time.

20. The method for management, according to claim 13, wherein the timer measures the operation time of said slave decoding device.

21. The method for management, according to claim 13, wherein the timer defines constant moments of activation.

22. The method for management, according to claim 13, wherein the timer measures the time period from a defined range of values.

23. The method for management, according to claim 13, characterized in that the controller monitoring operation of signal processing block in a waiting mode generates on a screen of TV receiver the time, which remains until transition to an inactive mode.

24. The method for management, according to claim 13, characterized in that the controller monitoring operation of signal processing block in inactive mode blocks a display of picture and/or sound of the received television signal.
